(19) United States
(12) Patent Application Publication
(10) Pub. No.: US 2012/0058026 A1
(43) Pub. Date: Mar. 8, 2012

(54) Microfluidic ejection device and method of manufacturing the same

(75) Inventors: Suk Ho Song, Ansan (KR); Changsung Sean Kim, Yongin (KR); Sang Jin Kim, Suwon (KR)

(73) Assignee: SAMSUNG ELECTRO-MECHANICS CO., LTD., Suwon (KR)

(21) Appl. No.: 12/929,170

(22) Filed: Jan. 5, 2011

(30) Foreign Application Priority Data
Sep. 3, 2010 (KR) 10-2010-0086472

(51) Int. Cl. B01L 3/00; B23P 11/00

(52) U.S. Cl. 422/504; 137/15.01

(57) ABSTRACT

There are disclosed a microfluidic ejection device and a method of manufacturing the same. The microfluidic ejection device includes a flow path plate having an inlet into which a microfluid is drawn, a pressure chamber connected with the inlet and having formed therein, a plurality of chamber units divided by a plurality of partitions, and a nozzle connected with the pressure chamber and ejecting the microfluid by integrating the microfluid, having passed through the plurality of chamber units, into a single flow path; and actuators formed on an upper portion of the flow path plate so as to respectively correspond to the plurality of chamber units and providing driving force for ejecting the microfluid from the pressure chamber to the nozzle. The microfluidic ejection device has superior microfluidic ejection performance because variations in pressure within the pressure chamber can be accurately adjusted.

### CROSS-REFERENCE TO RELATED APPLICATIONS

This application claims the priority of Korean Patent Application No. 10-2010-0086472 filed on Sep. 3, 2010, in the Korean Intellectual Property Office, the disclosure of which is incorporated herein by reference.

### BACKGROUND OF THE INVENTION

1. Field of the Invention

The present invention relates to a microfluidic ejection device and a method of manufacturing the same, and more particularly, to a microfluidic ejection device having superior microfluidic ejection performance and a method of manufacturing the same.

2. Description of the Related Art

Recently, the demand of a biomedical device and a bio-technology for promptly diagnosing a variety of human diseases has been increased. Accordingly, a biosensor and a bio-chip capable of showing test results with regard to a specific disease in a short period of time, particularly a disease for which testing has previously required a lengthy period of time in a hospital and a laboratory, have been actively developed.

Research into biosensors and bio-chips are required by pharmaceutical companies, cosmetics companies, and the like, as well as by hospitals. A method of verifying the effectiveness and safety (toxicity) of a specific drug by testing a cellular response to the specific drug has been used in the pharmaceutical and cosmetic fields. However, the related art method has disadvantages in that the costs and time required therefor are considerable. This is because the method requires the use of a large amount of reagent or the use of animal test subjects.

Therefore, the development of a biosensor or a bio-chip capable of performing a prompt and accurate diagnosis, while at the same time reducing costs, is required.

Recently, a single cell chip, in which individual single cells are patterned in the form of an array, unlike the bio-chip according to the related art, has been developed. In order to realize this cell chip, the method of ejecting biomaterials by employing a jetting method used for inkjet printing has been used.

Methods of ejecting biomaterials include a pneumatic method, in which the biomaterials are ejected by using air pressure, and a piezoelectric method in which the biomaterials are ejected by pressurizing a pressure chamber through the use of a piezoelectric ceramic. The pneumatic method is advantageous for ejecting high-viscosity materials including biomaterials, such as cells or the like with a relatively large size of droplets (on an nL scale). However, the pneumatic method has a limitation in that differences between the relative volumes of droplets may be significant. Meanwhile, the piezoelectric method has an advantage, in that it is capable of ejecting a small droplet (on a pL scale) with high precision because the variation in the volume of the pressure chamber, corresponding to the size of the droplet to be ejected, can be accurately adjusted.

### SUMMARY OF THE INVENTION

An aspect of the present invention provides a microfluidic ejection device having superior microfluidic ejection performance and a method of manufacturing the same.

According to an aspect of the present invention, there is provided a microfluidic ejection device, including a flow path plate having an inlet into which a microfluid is drawn, a pressure chamber connected with the inlet and having formed therein, a plurality of chamber units divided by a plurality of partitions, and a nozzle connected with the pressure chamber and ejecting the microfluid by integrating the microfluid, having passed through the plurality of chamber units, into a single flow path; and actuators formed on an upper portion of the flow path plate so as to respectively correspond to the plurality of chamber units and providing driving force for ejecting the microfluid from the pressure chamber to the nozzle.

The pressure chamber may be 1000 to 1500 μm in width, 2000 to 4000 μm in length, and 30 to 100 μm in height.

The flow path plate may become narrower in width from the pressure chamber to the nozzle.

The nozzle may become narrower in width in an ejection direction of the microfluid.

The flow path plate may include an upper substrate and a lower substrate, and the partitions may be formed in the upper substrate.

According to another aspect of the present invention, there is provided a method of manufacturing a microfluidic ejection device, the method including: preparing a flow path plate having a flow path formed therein, through which a microfluid is ejected from an inlet to a nozzle; forming a pressure chamber so as to have a plurality of chamber units divided by a plurality of partitions within the flow path plate transferring the microfluid from the inlet to the nozzle, integrate the microfluid having passed through the plurality of chamber units into a single flow path, and provide the microfluid integrated into the single flow path to the nozzle; and forming actuators formed on an upper portion of the flow path plate so as to respectively correspond to the plurality of chamber units and providing driving force for ejecting the microfluid from the pressure chamber to the nozzle.

The forming of the pressure chamber may be performed such that the pressure chamber is 1000 to 1500 μm in width, 2000 to 4000 μm in length, and 30 to 100 μm in height.

The preparing of the flow path plate may be performed such that the flow path plate becomes narrower in width from the pressure chamber toward the nozzle.

The nozzle may become narrower in width in an ejection direction of the microfluid.

The preparing of the flow path plate may include preparing the upper substrate and the lower substrate, and the partitions may be formed by processing the upper substrate.

The method of manufacturing a microfluidic ejection device may further include bonding the upper substrate and the lower substrate, wherein the bonding of the upper substrate and the lower substrate may be performed by silicon direct bonding (SDB).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is an exploded perspective view schematically illustrating a microfluidic ejection device according to an exemplary embodiment of the present invention;

FIG. 2A is a vertical cross-sectional perspective view of a microfluidic ejection device taken along line A-A′ of FIG. 1, and FIG. 2B is a vertical cross-sectional view of a microfluidic ejection device taken along line A-A′ of FIG. 1;

FIG. 3 is a vertical cross-sectional view of a microfluidic ejection device taken along line B-B′ of FIG. 1;

FIGS. 4A and 4B are process views showing a method of forming a microfluidic flow path in an upper substrate of a microfluidic ejection device according to an exemplary embodiment of the present invention, respectively; and

FIG. 5 is a process view showing a method of forming a microfluidic flow path in a lower substrate of a microfluidic ejection device according to an exemplary embodiment of the present invention.

### DETAILED DESCRIPTION OF THE PREFERRED EMBODIMENT

Exemplary embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and sizes of components are exaggerated for clarity. The same elements are referred to by the same reference numerals throughout the specification.

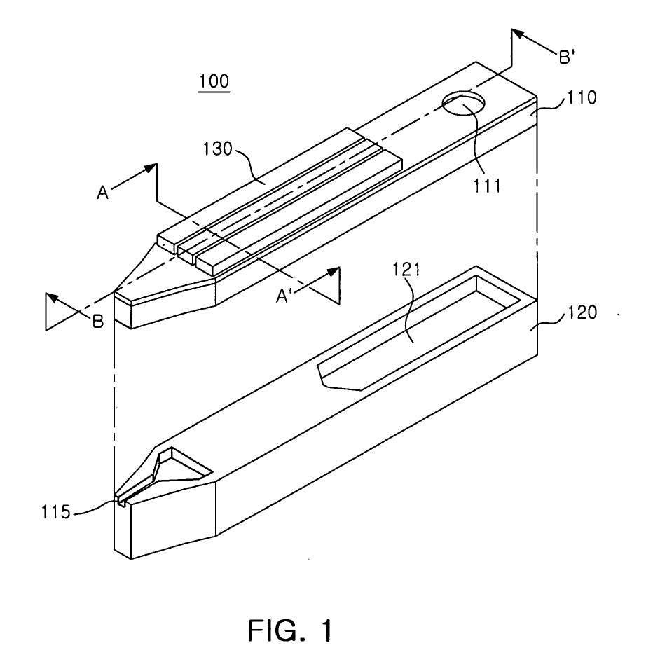

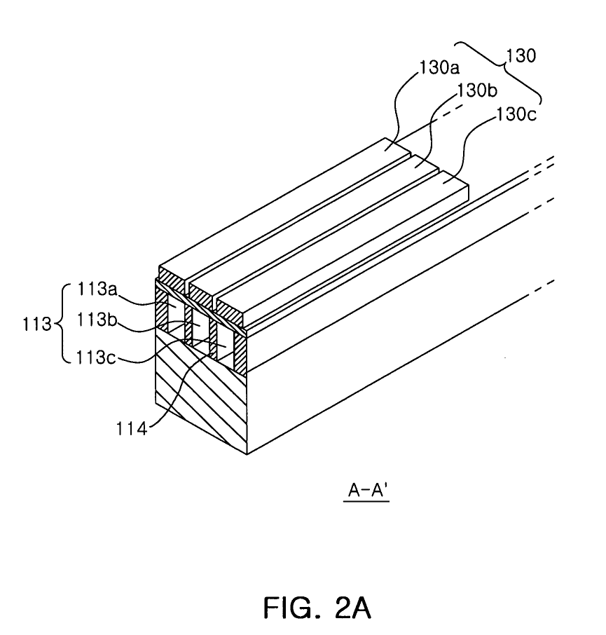

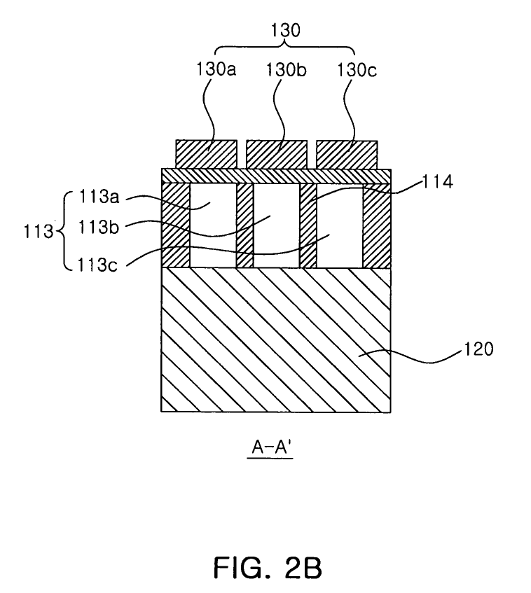

FIG. 1 is an exploded perspective view schematically illustrating a microfluidic ejection device according to an exemplary embodiment of the present invention. FIG. 2A is a vertical cross-sectional perspective view of a microfluidic ejection device taken along line A-A′ of FIG. 1, and FIG. 2B is a vertical cross-sectional view of a microfluidic ejection device taken along line A-A′ of FIG. 1. FIG. 3 is a vertical cross-sectional view of a microfluidic ejection device taken along line B-B′ of FIG. 1.

Referring to FIGS. 1 through 3, a microfluidic ejection device 100 according to an exemplary embodiment of the present invention may include a flow path plate including an upper substrate 110 and a lower substrate 120, and a piezoelectric actuator 130 formed on the upper surface of the upper substrate 110.

According to the exemplary embodiment of the present invention, a flow path is formed in the upper substrate 110 and the lower substrate 120, and the upper substrate 100 and lower substrate 120 may become narrower toward the nozzle 115.

The upper substrate 110 may include an inlet 111 into which a microfluid is drawn, a groove forming a restrictor 112, and a groove forming a pressure chamber 113 may be formed. At this time, the upper substrate 110 may be a single crystal silicon substrate or a silicon on insulator (SOI) wafer having two silicon layers and an insulating layer formed therebetween.

Here, when the directions of the microfluidic ejection device are defined, a thickness direction refers to a direction from the upper substrate 110 to the lower substrate 120 or vice-versa. A length direction refers to the flow path direction of the microfluidic ejection device, that is, a direction from the pressure chamber 113 to the nozzle 115 or vice-versa. A width direction refers to a direction perpendicular to the length direction. In addition, height refers to the dimension of the thickness direction.

In addition, a plurality of partitions 114 are formed in a groove in which the pressure chamber 113 of the upper substrate 110 is formed. A plurality of chamber units 113a, 113b, and 113c are formed in the pressure chamber 113 by the partitions 114. A plurality of flow paths are formed by the individual chamber units 113a, 113b, and 113c. An inlet portion 113d of the pressure chamber 113, connected with the restrictor 112, forms a single flow path. The single flow path is divided into the plurality of flow paths by the individual chamber units, and then the plurality of flow paths are reintegrated into a single flow path in an ejection portion 113e.

That is, the microfluid drawn from the restrictor 112 into the pressure chamber 113 is transferred through the individual flow paths within the chamber units 113a, 113b, and 113c divided by the partitions 114. Then, the individual flow paths are integrated into a single flow path in the nozzle 115 of the pressure chamber 113, and the microfluid integrated into the single flow path is ejected from the nozzle 115.

In the exemplary embodiment of the present invention, the three chamber units 113a, 113b, and 113c are formed by forming two partitions 114 within the pressure chamber 113. However, the present invention is not limited thereto, and the present invention may be modified according to required conditions and design specifications.

The piezoelectric actuator 130 is formed on the upper portion of the upper substrate 110, and provides driving force for ejecting the microfluid drawn into the pressure chamber 113 to the nozzle 115.

In the exemplary embodiment of the present invention, as the piezoelectric actuator 130, three piezoelectric actuators 130a, 130b, and 130c may be formed at locations respectively corresponding to the three flow paths within the chamber units 113a, 113b, and 113c divided by the partitions 114.

The piezoelectric actuator 130 may include a lower electrode acting as a common electrode, a piezoelectric film deformed according to applied voltage, and an upper electrode acting as a driving electrode.

The lower electrode may be formed on the entire surface of the upper substrate 110. The lower electrode may include a single conductive metallic material or two metallic thin films made of titanium (Ti) and platinum (Pt). The lower electrode may act as a diffusion barrier layer preventing interdiffusion between the piezoelectric film and the upper substrate 110, as well as act as the common electrode.

The piezoelectric film is formed on the lower electrode, and disposed so as to be located on the pressure chamber 113. This piezoelectric film may be made of a piezoelectric material, preferably, a lead zirconate-titanate (PZT) ceramic material. The upper electrode is formed on the piezoelectric film and may be made of any one of Pt, Au, Ag, Ni, Ti, Cu, and the like.

The lower substrate 120 may include a groove forming a reservoir 121 and a groove forming the nozzle 115 may be formed, and the reservoir 121 transfers the microfluid drawn into the inlet 111 to the pressure chamber 113 therethrough.

The lower substrate 120 may be the single crystal silicon substrate or the SOI wafer formed by sequentially stacking a lower silicon layer, an insulating layer, and an upper silicon layer.

In general, while an inkjet print head ejects droplets on the level of several to several tens of pL, an ejection device ejecting a biomaterial, such as a cell or the like, or a drug, needs to eject a large size of droplets on the level of hundreds of pL.

Accordingly, while the size of a pressure chamber in the inkjet printer head is on the level of 100 to 300 um, a pressure chamber in the ejection device for ejecting the microfluid containing the biomaterial or the drug is manufactured to have a considerably large size.

Thus, the size of the pressure chamber in the ejection device increases, and a pressure variation cycle within the pressure chamber is slower than that of the inkjet print head. Thus, while the inkjet print head has an ejection frequency performance of several tens of kHz band, the ejection device ejecting the microfluid containing the biomaterial or the drug could realize merely a very low frequency performance on the level of about 0.1 to 1 kHz band.

The microfluidic ejection device ejecting the microfluid containing the biomaterial or the drug needs to have stable ejection performance with respect to as many mediums as possible, because various kinds of biomaterial or drug may be mixed in the microfluid. A stable ejection involves a superior straightness of an ejected droplet, no satellite drop, and a superior velocity of the droplet (2˜3 m/s or more).

However, when the size of the pressure chamber becomes larger, it is very difficult to stably eject various kinds of medium. Even though the microfluidic ejection device may not generate the satellite drop and may exhibit an ejection performance having great straightness with respect to one medium, controlling the viscosity and surface tension of all mediums is difficult.

In general, in the case of a piezoelectric type inkjet print head using an actuator, the ejection quality of the droplet may be delicately adjusted by accurately adjusting the surface shape (meniscus) of the nozzle. However, in the case in which the size of the pressure chamber is large, it is difficult to accurately control variations in pressure within the pressure chamber.

However, according to the exemplary embodiment of the present invention, the microfluid drawn through the inlet 111 is transferred to the pressure chamber 113 by the reservoir 121. The microfluid transferred to the pressure chamber 113 is divided into the three flow paths by the individual chamber units 113a, 113b and 113c formed by the partitions 114. Then the three flow paths are driven by the actuators 130a, 130b, and 130c and integrated into a single flow path. The microfluid integrated into the single flow path is ejected to the nozzle.

That is, according to the exemplary embodiment of the present invention, the variations in pressure within the pressure chamber can be accurately adjusted and the natural frequency of a flow within the pressure chamber can be increased by dividing the pressure chamber into the plurality of chamber units. Accordingly, a frequency band in which the ejection of the microfluid is allowed can be increased than that in the related art.

Accordingly, in the microfluidic ejection device of the exemplary embodiment of the present invention, the pressure chamber may be 1000 to 1500 μm in width, 2000 to 4000 μm in length, and 30 to 100 μm in height.

In addition, according to the exemplary embodiment of the present invention, different voltages may be applied to the individual chamber units 113a, 113b and 113c by the individual piezoelectric actuators 130a, 130b, and 130c in order to stabilize the surface of a droplet to be ejected. Only a left or right chamber among the chamber units 113a, 113b and 113c may be manipulated to be biased and pressurized, for example.

In addition, an ejection device having a single pressure chamber could adjust the size of a droplet with only the displacement and waveform of a single piezoelectric actuator formed on the single pressure chamber. However, the ejection device according to the exemplary embodiment of the present intention may achieve droplets in various sizes by adjusting the number of chamber units employed therein, together with the displacements and waveforms of the plurality of piezoelectric actuators formed on the chamber units.

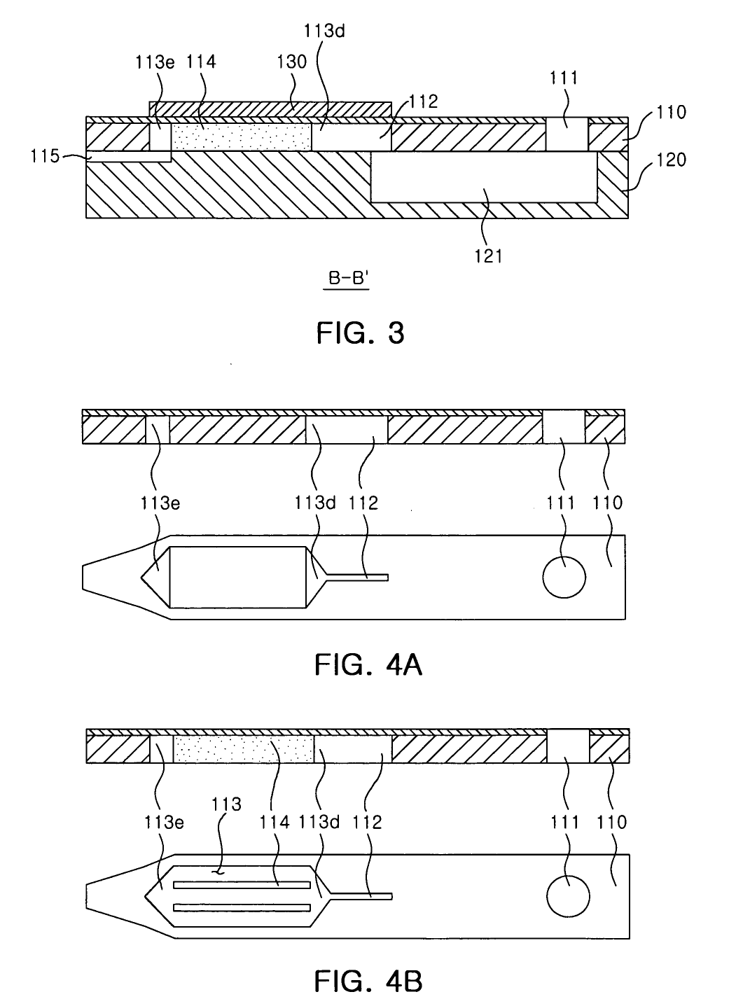

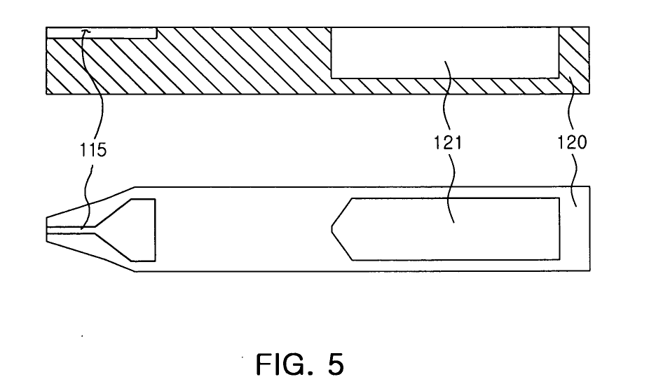

Referring to FIGS. 4 and 5, a method of manufacturing a microfluidic ejection device according to an exemplary embodiment of the present invention will be described as below.

FIGS. 4A and 4B are process views showing a method of forming a microfluidic flow path in an upper substrate of a microfluidic ejection device according to an exemplary embodiment of the present invention, respectively. FIG. 5 is a process view showing a method of forming a microfluidic flow path in a lower substrate of a microfluidic ejection device according to an exemplary embodiment of the present invention.

The method of manufacturing a microfluidic ejection device according to the exemplary embodiment of the present invention is schematically explained. A microfluidic flow path is formed in the upper substrate and the lower substrate. Then, the upper substrate and the lower substrate are stacked and bonded, thereby completing a microfluidic ejection device. Meanwhile, the processes of forming the flow path in the upper substrate and the lower substrate may be performed regardless of the order thereof. That is, the microfluidic flow path may be previously formed in any one of the upper substrate and the lower substrate. Alternatively, the microfluidic flow path may be formed in the upper substrate and the lower substrate at the same time. However, for convenience of explanation, the process of forming the microfluidic flow path in the upper substrate will be described in advance.

Referring to FIG. 4A, a silicon wafer having a thickness on the level of approximately 100 to 200 μm is prepared as the upper substrate 110. The prepared upper substrate 110 is subjected to wet or dry oxidation in order that a silicon oxide having a thickness on the level of approximately 5,000 to 15,000 Å may be formed on the upper surface and the bottom surface of the upper substrate 110.

In the upper substrate 110, grooves forming the restrictor 112, the inlet portion 113d of the pressure chamber 113, and the ejection portion 113 are formed, a through hole forming the inlet 111 is formed. The upper substrate 110 may become narrower in width toward the nozzle.

A method of forming the through hole in the upper substrate 110 may include applying a photoresist to the bottom surface of the upper substrate 110, patterning the applied photoresist, and etching the patterned photoresist as an etching mask. At this time, the patterning of the photoresist may be performed by a well known photolithography process including exposure and development. The patterning of the other photoresistors to be described later may be performed in the same manner.

In addition, etching methods for forming the flow path in the upper substrate 110 may be performed by a dry etching, such as a reactive ion etching (RIE) using inductively coupled plasma (ICP) or a wet etching, using, for example, tetramethyl ammonium hydroxide (TMAH) or potassium hydroxide (KOH) as an etchant used for silicon. The etching of this silicon wafer may be also applied to etchings performed with respect to other silicon wafers to be discussed later, in the same manner.

Next, as shown in FIG. 4B, in order to form the partitions 114 within the pressure chamber 113, the internal space of the pressure chamber 113 may be etched, except for portions on which the partitions 114 are to be formed.

Hereinafter, referring to FIG. 5, the process of forming a flow path in the lower substrate of the microfluidic ejection device according to an exemplary embodiment of the present invention is illustrated.

In the exemplary embodiment of the present invention, as the lower substrate 120, the SOI wafer formed of a lower silicon layer having a thickness of approximately hundreds of μm, preferably a thickness of approximately 210 μm, an insulating layer having a thickness of approximately 1 μm to 2 μm, and an upper silicon layer having a thickness of approximately 10 μm to 100 μm may be used. The prepared lower substrate 120 may be subjected to wet etching or dry etching, in order that a silicon oxide having a thickness of approximately 5,000˜15,000 Å may be formed on the upper and lower surfaces of the lower substrate 120.

Next, as shown in FIG. 5, the groove forming the reservoir 121 and the groove forming the nozzle 115 are formed in the lower substrate 120. The photoresist is applied to the upper surface of the lower substrate 120 so as to cover the upper surface of the lower substrate 120. The applied photoresist is patterned to form openings forming the nozzle 115 and the reservoir 121. Then, by using the patterned photoresist as the etching mask. The portions of the upper silicon layer, the insulating layer, and the lower silicon layer are etched to thereby form the groove forming the nozzle 115 and the groove forming the reservoir 121. The formation of the reservoir 121 groove may be performed by the wet etching or the dry etching. The side of the reservoir 121 may be etched to be inclined.

The lower substrate 120 may become narrower in width toward the nozzle. A portion, in which the nozzle is formed, may become narrower in width in the ejection direction of the microfluid. The width is gradually reduced in the exemplary embodiment of the present invention; however, an aspect how the width becomes narrower is not specifically limited.

In the above statement, the forming of the flow path by using the SOI wafer as the lower substrate 120 is illustrated and explained. However, the present invention is not limited thereto, and the single crystal silicon substrate may also be used as the lower substrate 120. That is, the single crystal silicon substrate having a thickness of approximately 100 to 200 μm is provided, and then the groove forming reservoir 121 may be formed in the lower substrate 120 in the same manner as illustrated in FIG. 5.

The upper substrate 110 and the lower substrate 120 individually having the flow path formed therein in these manners are bonded. Then, the piezoelectric actuator 130 is formed at a location on the upper substrate 110, corresponding to the pressure chamber 113. The microfluidic ejection device is completed as shown in FIG. 1.

In this case, bonding between the upper substrate 110 and the lower substrate 120 may be performed by silicon direct bonding (SDB). The bottom surface of the upper substrate 110 and the upper surface of the lower substrate 120 are used as bonding surfaces. These bonding surfaces are adhered closely and thermally treated, thereby being bonded together.

The piezoelectric actuators 130 may be formed on the upper surface of the upper substrate 110 and disposed at locations respectively corresponding to the plurality of flow paths formed by the plurality of unit chambers. In the exemplary embodiment of the present invention, the three piezoelectric actuators 130a, 130b, and 130c may be formed so as to correspond to the spaces of the individual chamber units 113a, 113b, and 113c divided by the two partitions 114.

As set forth above, according to exemplary embodiments of the invention, the variations in pressure within the pressure chamber can be accurately adjusted and the natural frequency of a flow within the pressure chamber can be increased by dividing the pressure chamber into the plurality of chamber units. Accordingly, a frequency band in which the ejection of the microfluid is allowed can be increased to be greater than before.

In addition, in order to stabilize the surface of the droplet to be ejected, different voltages may be applied to the individual chamber units and only some of the chamber units can be manipulated to be biased and pressurized.

While the present invention has been shown and described in connection with the exemplary embodiments, it will be apparent to those skilled in the art that modifications and variations can be made without departing from the spirit and scope of the invention as defined by the appended claims.

What is claimed is:

1. A microfluidic ejection device comprising:
a flow path plate having an inlet into which a microfluid is drawn, a pressure chamber connected with the inlet and having formed therein, a plurality of chamber units divided by a plurality of partitions, and a nozzle connected with the pressure chamber and ejecting the microfluid by integrating the microfluid, having passed through the plurality of chamber units, into a single flow path; and
actuators formed on an upper portion of the flow path plate so as to respectively correspond to the plurality of chamber units and providing driving force for ejecting the microfluid from the pressure chamber to the nozzle.

2. The microfluidic ejection device of claim 1, wherein the pressure chamber is 1000 to 1500 μm in width, 2000 to 4000 μm in length, and 30 to 100 μm in height.

3. The microfluidic ejection device of claim 1, wherein the flow path plate becomes narrower in width from the pressure chamber toward the nozzle.

4. The microfluidic ejection device of claim 1, wherein the nozzle becomes narrower in width in an ejection direction of the microfluid.

5. The microfluidic ejection device of claim 1, wherein the flow path plate includes an upper substrate and a lower substrate, and the partitions is formed in the upper substrate.

6. A method of manufacturing a microfluidic ejection device, the method comprising:
preparing a flow path plate having a flow path formed therein, through which a microfluid is ejected from an inlet to a nozzle;
forming a pressure chamber so as to have a plurality of chamber units divided by a plurality of partitions within the flow path plate transferring the microfluid from the inlet to the nozzle, integrate the microfluid having passed through the plurality of chamber units into a single flow path, and provide the microfluid integrated into the single flow path to the nozzle; and
forming actuators formed on an upper portion of the flow path plate so as to respectively correspond to the plurality of chamber units and providing driving force for ejecting the microfluid from the pressure chamber to the nozzle.

7. The method of claim 6, wherein the forming of the pressure chamber is performed such that the pressure chamber is 1000 to 1500 μm in width, 2000 to 4000 μm in length, and 30 to 100 μm in height.

8. The method of claim 6, wherein the preparing of the flow path plate is performed such that the flow path plate becomes narrower in width from the pressure chamber toward the nozzle.

9. The method of claim 6, wherein the nozzle becomes narrower in width in an ejection direction of the microfluid.

10. The method of claim 6, wherein the preparing of the flow path plate comprises preparing the upper substrate and the lower substrate,
wherein the partitions is formed by processing the upper substrate.

11. The method of claim 10, further comprising bonding the upper substrate and the lower substrate, wherein the bonding of the upper substrate and the lower substrate is performed by silicon direct bonding (SDB).
